(19) United States
(12) Patent Application Publication
(10) Pub. No.: US 2025/0016122 A1
(43) Pub. Date: Jan. 9, 2025

(54) METHOD AND APPARATUS FOR MESSAGING SERVICE

(71) Applicant: KAKAO CORP., Jeju-si (KR)

(72) Inventors: Hye Jung ROH, Seongnam-si (KR); Na Aeng YOO, Seongnam-si (KR); Song Jin KIM, Seongnam-si (KR)

(21) Appl. No.: 18/764,995

(22) Filed: Jul. 5, 2024

(30) Foreign Application Priority Data
Jul. 6, 2023 (KR) 10-2023-0088041

(51) Int. Cl. H04L 51/04; G06F 21/31; G06Q 20/38; H04L 51/063

(52) U.S. Cl. CPC H04L 51/04; G06F 21/31; G06Q 20/386; H04L 51/063

(57) ABSTRACT

A messaging service method and apparatus are disclosed. A method of operating an instant messaging server, according to an embodiment, may include sending, through a chat room, a message on which display of content is restricted based on settings of a restricted view condition for the message. The method may include receiving a request to view the message from a terminal of a participant in the chat room. The method may include activating the display of the content of the message on the terminal of the participant, based on whether the participant satisfies the restricted view condition.

### CROSS-REFERENCE TO RELATED APPLICATIONS

This application claims priority under 35 USC § 119 (a) to Korean Patent Application No. 10-2023-0088041 filed on Jul. 6, 2023, in the Korean Intellectual Property Office, the disclosure of which is incorporated by reference herein in its entirety.

### BACKGROUND

### Technical Field

The following description relates to a messaging service method and apparatus.

### Description of the Related Art

A recent advancement in mobile smart devices has increased the use of online platform services for interaction with other users over a network. The online platform services for interaction with other users may include, as representative examples, a social networking service (SNS) which is an online platform for generating and consolidating social relationships through communication among users, information sharing, and expansion of personal connections, and an instant messaging service (IMS) which is an online platform for real-time content communication between two or more users. As communication through the mobile devices grows, the online platform services may support communication functions using various types of messages exchanged with other users.

### BRIEF SUMMARY

Various embodiments of the present disclosure provide a technology for setting restrictions on a message sent through a single chat room and controlling whether to display content included in the message by each receiver of the message participating in the chat room.

However, various embodiments are not limited to the preceding aspect, and there may be other technical aspects.

According to some embodiments, there is provided a method of operating an instant messaging server, the method including: sending, through a chat room, a message for which display of content is restricted based on settings of a restricted view condition for the message; receiving a request to view the message from a terminal of a participant in the chat room; and activating the display of the content of the message on the terminal of the participant, based on whether the participant satisfies the restricted view condition.

The activating of the display of the content of the message may include: in response to the participant not satisfying the restricted view condition, requesting the terminal of the participant for an action required by the restricted view condition; and activating the display of the content of the message on the terminal of the participant based on the action being performed.

The method may further include, in response to the action not being performed, deactivating the display of the content of the message on the terminal of the participant.

The action required by the restricted view condition may include at least one of a payment action and an authentication action.

The method may further include setting the restricted view condition for the message, based on a set value of the restricted view condition input from a terminal of a sender of the message.

The restricted view condition may include at least one of a payment-type restricted view condition that requires a payment to view, or an authentication-type restricted view condition that requires authentication to view.

The restricted view condition may be set for at least a portion of the content included in the message.

The restricted view condition may be set for each participant in the chat room.

The message, for which the restricted view condition is set, may be restricted in at least one of sharing, copying, and capturing.

According to some embodiments, there is provided a method of operating a terminal executing an instant messenger, the method including: determining a type of a restriction condition for a message; determining a set value of the restriction condition based on the determined type; and requesting transmission of the message for which the restriction condition is set, based on the set value.

The type of the restriction condition may include at least one of a payment-type restricted view condition that requires a payment to view, an authentication-type restricted view condition that requires authentication to view, or a sharing-related restriction condition.

According to some embodiments, there is provided a method of operating a terminal executing an instant messenger, the method including: receiving a message for which a restricted view condition is set; performing an action required by the restricted view condition; and displaying content of the message based on a result of performing the action.

According to some embodiments, there is provided an instant messaging server including a processor configured to: send, through a chat room, a message for which display of content is restricted based on settings of a restricted view condition for the message; receive a request to view the message from a terminal of a participant in the chat room; and activate the display of the content of the message on the terminal of the participant, based on whether the participant satisfies the restricted view condition.

The processor may be configured to: when activating the display of the content of the message, in response to the participant not satisfying the restricted view condition, request the terminal of the participant for an action required by the restricted view condition; and activate the display of the content of the message on the terminal of the participant based on the action being performed.

The processor may be configured to, in response to the action not being performed, deactivate the display of the content of the message on the terminal of the participant.

The processor may be configured to: set the restricted view condition for the message, based on a set value of the restricted view condition input from a terminal of a sender of the message.

The restricted view condition may include at least one of a payment-type restricted view condition that requires a payment to view or an authentication-type restricted view condition that requires authentication to view.

According to some embodiments, there is provided a terminal executing an instant messenger, the terminal including a processor configured to: determine a type of a restriction condition for a message; determine a set value of the restriction condition based on the determined type; and request transmission of the message for which the restriction condition is set, based on the set value.

According to some embodiments, there is provided a terminal executing an instant messenger, the terminal including a processor configured to: receive a message for which a restricted view condition is set; perform an action required by the restricted view condition; and display content of the message based on a result of performing the action.

### BRIEF DESCRIPTION OF THE SEVERAL VIEWS OF THE DRAWINGS

The above and other features of certain embodiments of the present disclosure will be more apparent from the following detailed description, taken in conjunction with the accompanying drawings, in which:

FIG. 1 is a diagram illustrating a system for an instant messaging service (IMS) according to an embodiment;

FIG. 2 is a flowchart illustrating a method of operating an instant messaging server according to an embodiment;

FIG. 3 is a diagram illustrating an example of controlling the display of content of a message for which a restricted view condition is set on a terminal of a participant in a chat room according to an embodiment;

FIG. 4 is a flowchart illustrating a method of operating a terminal executing an instant messenger according to an embodiment;

FIGS. 5A through 5C are diagrams illustrating example interface screens for determining a set value of a restricted view condition according to an embodiment;

FIG. 6 is a flowchart illustrating a method of operating a terminal executing an instant messenger according to an embodiment;

FIGS. 7A through 7C are diagrams illustrating example interface screens of a terminal receiving a message for which a payment-type restricted view condition is set according to an embodiment;

FIGS. 8A through 8D are diagrams illustrating example interface screens of a terminal receiving a message for which an authentication-type restricted view condition is set according to an embodiment;

FIGS. 9A and 9B are diagrams illustrating example messages for which a restricted view condition is set for a portion of content according to an embodiment;

FIGS. 10A and 10B are diagrams illustrating example messages for which a sharing-related restriction condition is set according to an embodiment; and

FIG. 11 is a diagram illustrating an example of a hardware configuration of a system for an IMS according to an embodiment.

### DETAILED DESCRIPTION

The following detailed structural or functional description is provided only for the purpose of providing examples, and various alterations and modifications may be made to the examples. Here, the examples are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that, if one component is described as “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the disclosure of the present application and is not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components and a repeated description related thereto will be omitted.

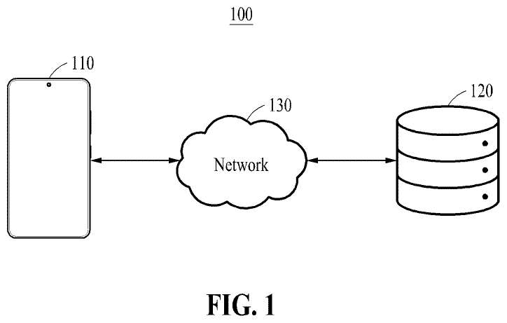

FIG. 1 is a diagram illustrating a system for an instant messaging service (IMS) according to an embodiment.

Referring to FIG. 1, according to an embodiment, a system 100 for an IMS may include a terminal 110, a server 120, and a network 130. A hardware configuration of each of the server 120 and the terminal 110 will be described in detail below.

According to an embodiment, the server 120 may include a server configured to provide an IMS through the network 130. For example, the server 120 may include a server configured to provide an IMS for sending and receiving messages about gifts. An IMS may include a service for sending instant messages, such as, text messages, voice messages, media files, and the like, in real time over the network 130 such as a wireless Internet or wireless communication network to allow a plurality of users to conduct a real-time chat, and a service related thereto.

The server 120 may be linked with an application (hereinafter also referred to as an “app”) or a web related to an IMS executed on the terminal 110 for a user interface (UI), function, operation, or service. Hereinafter, the app or web related to the IMS will be referred to as an instant messenger.

The terminal 110 may be any electronic device capable of installing and executing an app, such as, for example, a computer, a portable computer, a wireless phone, a mobile phone, a smartphone, a personal digital assistant (PDA), a web tablet, a wearable device, and the like. In this case, the terminal 110 may receive a service and/or content through the app. For example, the terminal 110 may perform overall operations related to the service, such as, for example, configuring a service screen, entering data, transmitting and receiving data, and storing data, under the control of the app. For example, the terminal 110 may process a UI or a user interaction through a processor, and output or transmit a result of the processing through an output device of the terminal 110.

The terminal 110 may be driven by the instant messenger provided by the server 120. A user may execute the instant messenger on the terminal 110 to use the IMS provided by the server 120. The user may create a user account by subscribing to the IMS through the instant messenger. The user may use the IMS through the terminal 110 of the user account subscribed to the IMS. The terminal 110 of the user account subscribed to the IMS may refer to a terminal logged in with the user account subscribed to the IMS.

According to an embodiment, a chat interface may be provided on the terminal 110 through an app for a messaging service. The chat interface may refer to an interface for sending and receiving messages on the messaging service and may include, for example, an interface that provides a function for sending messages through a chat room in which at least one user account participates and displaying received messages. The chat interface may correspond to a chat room, which is a virtual space in which at least one user account participates and participants chat with each other.

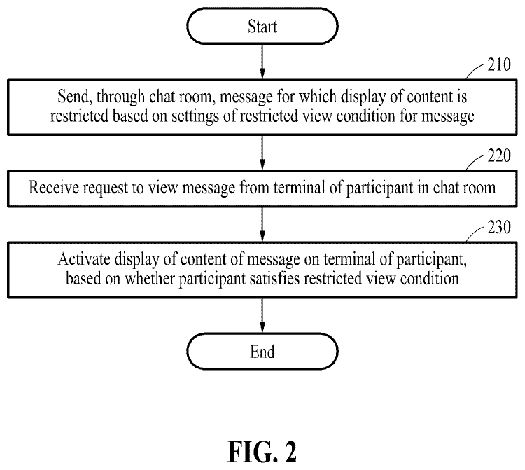

FIG. 2 is a flowchart illustrating a method of operating an instant messaging server according to an embodiment.

According to an embodiment, an instant messaging server may correspond to the server 120 of FIG. 1. Hereinafter, the instant messaging server will be referred to as a “server” for simplicity.

Referring to FIG. 2, according to an embodiment, a method of operating the server may include operation 210 of sending, through a chat room, a message for which the display of content is restricted, based on settings of a restricted view condition for the message.

The restricted view condition for a message, which refers to a condition set to restrict viewing of at least some of content included in the message, may include at least one of, for example, a payment-type restricted view condition that requires a payment to view and an authentication-type restricted view condition that requires authentication to view.

The restricted view condition may correspond to a condition for a restriction (also herein a “restriction condition”) set for a message. The restriction condition may further include a sharing-related condition in addition to the restricted view condition. The sharing-related condition may include, for example, at least one of a restricted share condition, a restricted copy condition, and a restricted capture condition. The restricted view condition of a message can be activated or deactivated.

The restricted share condition may refer to a condition that restricts message sharing. For example, for a message for which the restricted share condition is set, a sharing function of sending the message through other chat rooms, except the one initially sending the message, may be deactivated.

The restricted copy condition may refer to a condition that restricts message copying. For example, for a message for which the restricted copy condition is set, a function of copying and pasting content included in the message may be deactivated.

The restricted capture condition may refer to a condition that restricts message capturing. For example, for a message for which the restricted capture condition is set, a capturing function of storing the message as an image may be deactivated. For example, in a case where the restricted capture condition is set for a message, the capturing function of a terminal to capture a screen on which the message is displayed may be deactivated.

For example, in the case of the payment-type restricted view condition that requires a payment to view, the restricted view condition may be determined to be satisfied when an amount required under the restricted view condition is paid. For example, in the case of the authentication-type restricted view condition that requires authentication to view, the restricted view condition may be determined to be satisfied when authentication under the restricted view condition is performed. A detailed set value of the restricted view condition will be described below.

In a case where the restricted view condition is set for a message, displaying content included in the message on a terminal of a user account receiving the message may be restricted. On a terminal of a user account that does not satisfy the restricted view condition, at least a portion of the content included in the message may not be displayed. On a terminal of a user account that satisfies the restricted view condition, the content included in the message may be displayed.

A message may include various types of content such as a text, an image, and a video. The restricted view condition may be set for an entire message or a portion of content included in the message. On a terminal of a user account that does not satisfy the restricted view condition, a portion of content included in the message, for which the restricted view condition is set, may not be displayed, but a portion of the content for which the restricted view condition is not set may be displayed. On a terminal of a user account that satisfies the restricted view condition, the entire content included in the message may be displayed.

According to an embodiment, the method of operating the server may include setting the restricted view condition for a message, based on a set value of the restricted view condition input from a terminal of a sender of the message. The set value of the restricted view condition may be determined by the sender of the message. The set value of the restricted view condition will be described in detail below.

According to an embodiment, the restricted view condition may be set for each participant in a chat room. A participant(s) in a chat room may correspond to a user account(s) participating in the chat room to which a message is sent. Whether to set the restricted view condition may be determined for each participant in the chat room. For example, the restricted view condition may be set for a first user account among participants in a chat room, and the restricted view condition may not be set for a second user account among the participants in the chat room. The set value of the restricted view condition may be determined for each participant in a chat room. For example, the restricted view condition corresponding to a first user account among participants in a chat room may be the payment-type restricted view condition, and the restricted view condition corresponding to a second user account among the participants in the chat room may be the authentication-type restricted view condition. For example, a set value of the restricted view condition corresponding to the first user account among the participants in the chat room and a set value of the restricted view condition corresponding to the second user account among the participants in the chat room may differ at least partially.

According to an embodiment, the method of operating the server may include operation 220 of receiving a request to view the message from a terminal of a participant in the chat room. The terminal of the participant in the chat room may receive, through the chat room, the message for which the restricted view condition is set. The server may control the terminal of the participant to deactivate the display of the content of the message for which the restricted view condition is set.

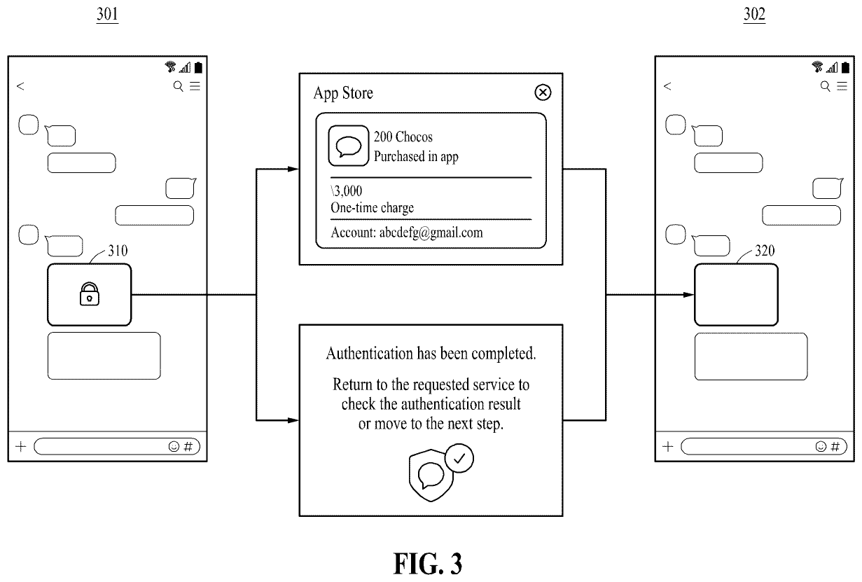

For example, screen 301 of FIG. 3 is an example screen of a chat room interface provided through a terminal of a participant in a chat room. Referring to the screen 301 of FIG. 3, a message 310 for which the restricted view condition is set, which is sent through the chat room, may be displayed on the chat room interface. In this case, content of the message 310 for which the restricted view condition is set may not be displayed on the terminal of the participant in the chat room. Instead of the content included in the message 310, a symbol indicating that it is a message for which the restricted view condition is set may be displayed. For example, a request to view the message 310 may be made to the server through an input selecting the message 310.

Referring again to FIG. 2, according to an embodiment, the method of operating the server may include operation 230 of activating the display of the content of the message on the terminal of the participant based on whether the participant satisfies the restricted view condition.

According to an embodiment, operation 230 of activating the display of the content of the message may include requesting the terminal of the participant for an action required by the restricted view condition when the participant does not satisfy the restricted view condition, and activating the display of the content of the message on the terminal of the participant based on the required action according to the restricted view condition being performed.

For example, referring to FIG. 3, when a request to view the message 310 is made through an input selecting the message 310, the server may request the terminal of the participant for an action required by the restricted view condition. For example, the server may provide the terminal of the participant with an interface for performing the action required by the restricted view condition. The participant may perform the action required by the restricted view condition through the interface for the action. The interface for an action will be described in detail below.

For example, in a case where the restricted view condition is the payment-type restricted view condition, an action required by the restricted view condition may include a payment action. For example, in a case where the restricted view condition is the authentication-type restricted view condition, an action required by the restricted view condition may include an authentication action.

When the action required by the restricted view condition is performed, the server may control the terminal of the participant to activate the display of the content of the message for which the restricted view condition is set. For example, as shown in screen 302 of FIG. 3, when the action required by the restricted view condition is performed, the symbol indicating that it is a message for which the restricted view condition is set may be removed from the terminal of the participant, and content of the message 320 may be displayed.

Referring again to FIG. 2, according to an embodiment, the method of operating the server may include deactivating the display of the content of the message on the terminal of the participant when the action required by the restricted view condition is not performed. When the action required by the restricted view condition is not performed, the restricted view condition may remain unsatisfied, and thus the content of the message may not be displayed on the terminal of the participant.

According to an embodiment, for a message for which the restricted view condition is set, at least one of sharing, copying, and capturing may be restricted. That is, for the message for which the restricted view condition is set, at least one of a restricted share condition, a restricted copy condition, and a restricted capture condition may be further set. For example, even on a terminal on which the content of the message is displayed when the restricted view condition is satisfied after the action required by the restricted view condition is performed, at least one of a sharing function, a copying function, and a capturing function for the message may be restricted.

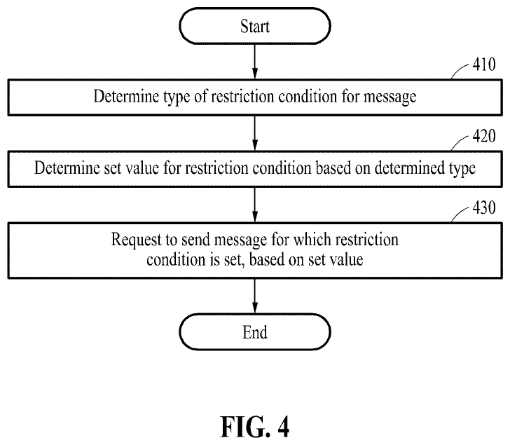

FIG. 4 is a flowchart illustrating a method of operating a terminal executing an instant messenger according to an embodiment.

According to an embodiment, a terminal executing an instant messenger, which is a terminal of a sender of a message for which a restriction condition is set, may correspond to the terminal 110 of FIG. 1. The sender may refer to a user account requesting the transmission of the message for which the restricted view condition is set. Hereinafter, the terminal executing the instant messenger will be referred to as a “terminal” for simplicity.

Referring to FIG. 4, according to an embodiment, a method of operating the terminal may include operation 410 of determining a type of restriction condition for a message. For example, the type of restriction condition may include a restricted view condition and a sharing-related restriction condition. The restricted view condition may include at least one of a payment-type restricted view condition and an authentication-type restricted view condition. The sharing-related restriction condition may include at least one of a restricted share condition, a restricted copy condition, and a restricted capture condition.

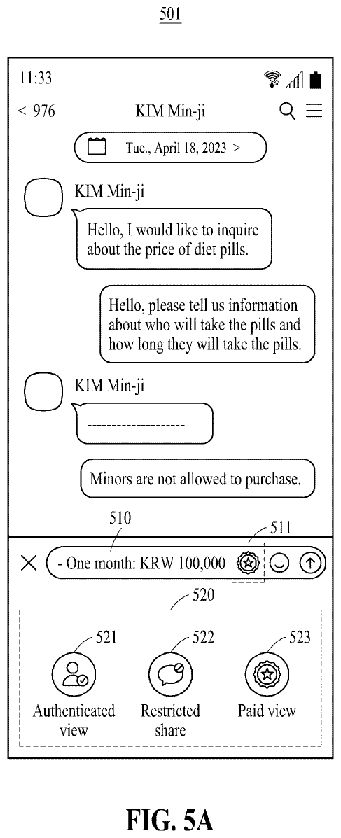

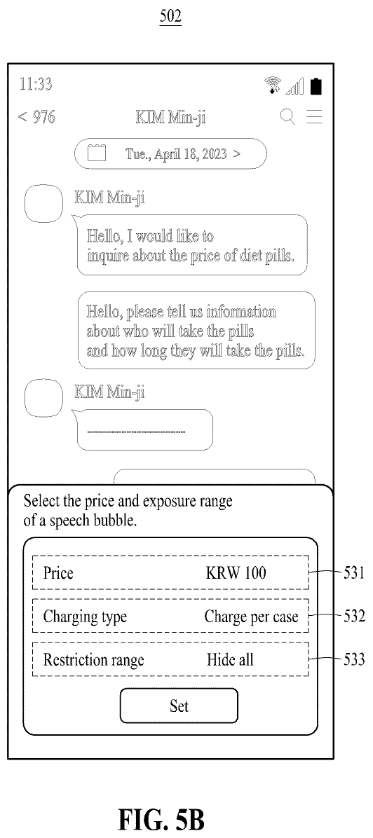

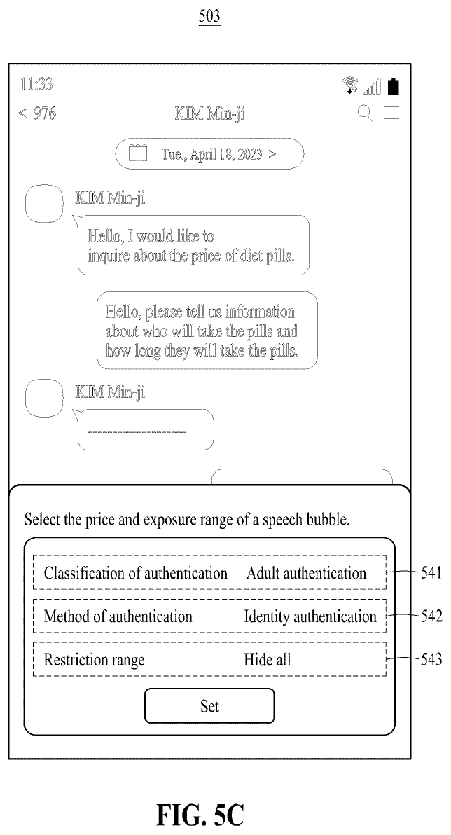

For example, screen 501 of FIG. 5A is an example screen of a chat interface provided onto a terminal of a sender. Referring to the screen 501, in response to an input selecting a button 511 for setting a restriction condition, an interface 520 may be provided to determine a type of the restriction condition for a message input to a text input window 510. For example, in response to an input selecting a first button 521, the type of the restriction condition for the message may be determined to be the authentication-type restricted view condition. For example, in response to an input selecting a second button 522, the type of restriction condition for the message may be determined to be the sharing-related restriction condition. For example, in response to an input selecting a third button 523, the type of restriction condition for the message may be determined to be the payment-type restricted view condition.

Referring again to FIG. 4, according to an embodiment, the method of operating the terminal may include operation 420 of determining a set value of the restriction condition based on the determined type. For each type of the restriction condition, a type of data to be input to set the restriction condition may differ.

According to an embodiment, when the determined type of the restriction condition is the payment-type restricted view condition, a set value of at least one of a price, a charging method, and a restriction range may be determined. For example, when the type of the restriction condition for a message is determined to be the payment-type restricted view condition in response to an input selecting the third button 523 from the screen 501 of FIG. 5A, an interface for determining a set value for the payment-type restricted view condition may be provided, as shown in screen 502 of FIG. 5B.

Referring to the screen 502 of FIG. 5B, a set value of a price (e.g., KRW 100 won) may be input through an input window 531 for determining the price. The price may correspond to an amount that needs to be paid to view the message for which the restriction condition is set.

For example, a set value of a charging method (e.g., charging per case) may be input through an input window 532 for determining the charging method. The charging method may be determined by selecting one from among set values of selected (or in some cases, predetermined) charging methods. In this case, the set values of the selected (or in some cases, predetermined) charging methods may include at least one of a value indicative of a charging method for each case (or transaction), a value indicative of a charging method based on a period (e.g., daily, monthly, yearly, etc.), and a value indicative of a charging method based on the number of times.

The charging method for each case may charge a price for a message for which the payment-type restricted view condition is set, and when a payment is made for the message once, viewing the message may be available regardless of the number of times and the period for viewing the message.

The charging method based on a period may charge a price based on a selected (or in some cases, predetermined) period of time for viewing a message for which the payment-type restricted view condition is set, and when a payment is made for the message once, viewing the message may be available for the selected (or in some cases, predetermined) period of time. For example, the charging method based on a period may include at least one of a per-message charging method based on a period and a per-chatroom charging method based on a period. The per-message charging method based on a period may be a method that, when a payment for a message for which a restriction condition is set is made once, may allow the message to be viewed for a selected (or in some cases, predetermined) period of time regardless of the number of times of viewing. The per-chatroom charging method based on a period may be a method that, when a payment for a specific chat room is made once, may allow a message(s) for which a restriction condition is set, sent through the chat room, to be viewed for a selected (or in some cases, predetermined) period of time regardless of the number of times of viewing.

The charging method based on the number of times may charge a price for each time of viewing a message for which a restriction condition is set, and when a payment is made once, may allow the message to be viewed once.

For example, a set value (e.g., hide all content) of a restriction range may be input through an input window 533 for determining the restriction range. The restriction range may refer to a range of content for which the payment-type restricted view condition is set, and entire or partial content may be set as the restriction range.

According to an embodiment, when the determined type of the restriction condition is the authentication-type restricted view condition, a set value of at least one of an authentication classification, an authentication method, and a restriction range may be determined. For example, when the type of the restriction condition for a message is determined to be the authentication-type restricted view condition in response to an input selecting the first button 521 from the screen 501 of FIG. 5A, an interface for determining a set value of the authentication-type restricted view condition may be provided, as shown in screen 503 of FIG. 5C.

Referring to the screen 503 of FIG. 5C, a set value of an authentication classification (e.g., adult authentication) may be input through an input window 541 for determining the authentication classification. The authentication classification may be determined by selecting one from among set values of selected (or in some cases, predetermined) authentication classifications. For example, the set values of the selected (or in some cases, predetermined) authentication classifications may include at least one of a value indicative of real name authentication, a value indicative of adult authentication, a value indicative of credential authentication, and a value indicative of member authentication.

For example, a set value (e.g., identity authentication) of an authentication method may be input through an input window 542 for determining the authentication method. The authentication method may be determined based on an authentication means linked with an IMS. For example, the authentication method may include at least one of an identity certificate and credential information (e.g., driver's license, student identification (ID) card, employee ID card, and other credentials) of an account obtained through an authentication server linked with the IMS. For example, the authentication method may include an identifier (e.g., membership authentication code) registered in the IMS.

For example, a set value (e.g., hide all content) of a restriction range may be input through an input window 543 for determining the restriction range. The restriction range may refer to a range of content for which the authentication-type restricted view condition is set, and entire or partial content may be set as the restriction range.

Referring again to FIG. 4, according to an embodiment, the method of operating the terminal may include operation 430 of requesting transmission of the message for which the restriction condition is set, based on the set value. The terminal may request the server to send the message for which the restriction condition is set, and the server may send the message for which the restriction condition is set to a terminal of a participant in a chat room through the chat room. The server may control the terminal of the participant to restrict the display of the content of the message based on the set value of the restriction condition set for the message.

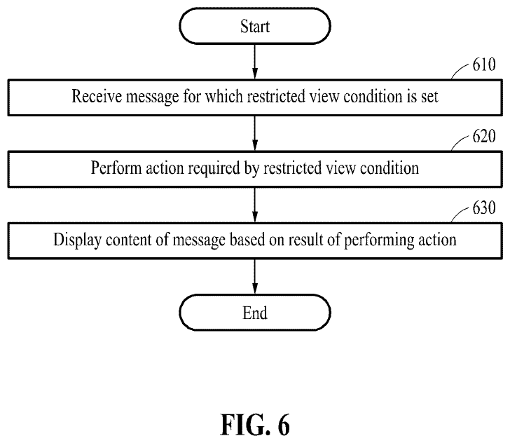

FIG. 6 is a flowchart illustrating a method of operating a terminal executing an instant messenger thereon according to an embodiment.

According to an embodiment, a terminal executing an instant messenger may be a terminal of an account of a receiver of a message for which a restricted view condition is set or a terminal of a user account of a user participating in a chat room to which the message for which the restricted view condition is set is sent, and may correspond to the terminal 110 of FIG. 1. Hereinafter, the terminal executing the instant messenger will be referred to as a “terminal” for simplicity.

Referring to FIG. 6, according to an embodiment, the method of operating the terminal may include operation 610 of receiving a message for which a restricted view condition is set. In this case, when an account logged into the terminal does not satisfy the restricted view condition for the message, content of the message for which the restricted view condition is set may not be displayed on the terminal.

According to an embodiment, the method of operating the terminal may include operation 620 of performing an action required by the restricted view condition. For example, in a case where the restricted view condition is a payment-type restricted view condition, the action required by the restricted view condition may include a payment action. For example, in a case where the restricted view condition is an authentication-type restricted view condition, the action required by the restricted view condition may include an authentication action.

According to an embodiment, operation 620 of performing the action required by the restricted view condition may be omitted when the restricted view condition is already satisfied on an account of the terminal.

According to an embodiment, the method of operating the terminal may include operation 630 of displaying content of the message based on a result of performing the action. When the restricted view condition is satisfied after the action is performed, the content of the message for which the restricted view condition is set may be displayed on the terminal.

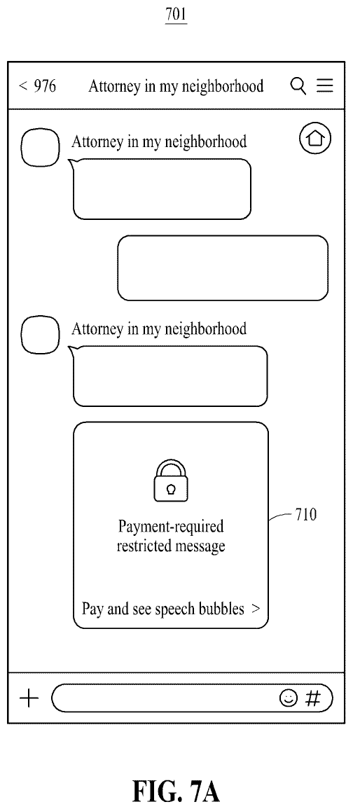

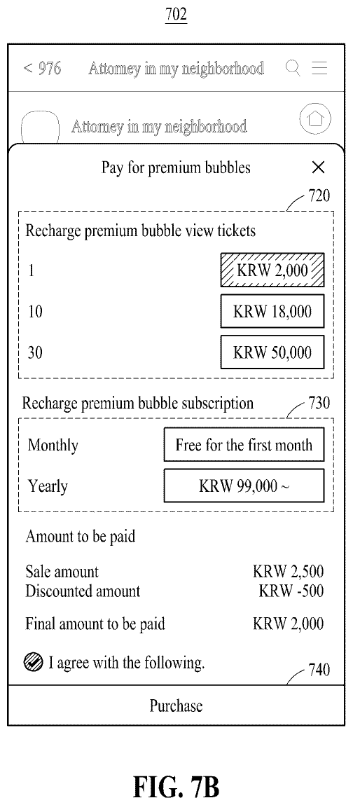

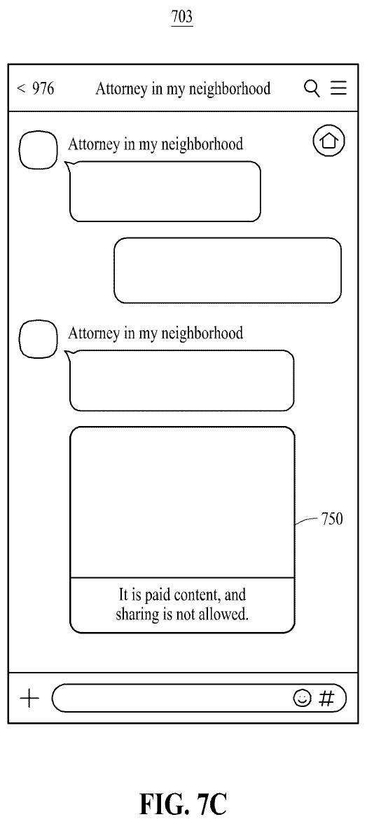

FIGS. 7A through 7C are diagrams illustrating example interface screens of a terminal receiving a message for which a payment-type restricted view condition is set according to an embodiment.

Screen 701 of FIG. 7A is an example screen of a chat room interface provided through a terminal of a participant in a chat room. Referring to the screen 701, a message 710 for which a condition requiring a payment for viewing is set, which is sent through the chat room, may be displayed on the chat room interface. Before the payment, content of the message 710 for which the condition requiring a payment for viewing is set may not be displayed on the terminal of the participant. Instead of the content included in the message 710, a symbol may be displayed to indicate that it is a message for which the condition requiring a payment is set.

According to an embodiment, the terminal may request the server to view the message 710. In response to the request to view the message 710 received from the terminal, the server may provide an interface for a payment action required by the condition requiring the terminal to make a payment. For example, in response to an input selecting the message 710, a signal requesting the server to view the message 710 may be transmitted, and the screen 701 may be changed to screen 702 of the interface for the payment action, as shown in FIG. 7B.

Referring to the screen 702 of FIG. 7B, the interface for performing the payment action may be provided onto the terminal of the participant, based on a set value of the payment-type restricted view condition. For example, the interface for performing the payment action may be used to provide a list 720 of view tickets and a list 730 of subscription tickets, for which purchases are required to view the message. The list 720 of view tickets and the list 730 of subscription tickets may be determined based on a set value of a price and a set value of a charging method, which are set for the message.

For example, in a case where the set value of the charging method included in the payment-type restricted view condition is a value indicative of a charging method for each case, the list 720 of view tickets may be provided. One view ticket may correspond to a right required to view a message once, and a price of the view ticket may be determined by the set value of the price included in the payment-type restricted view condition for the message.

For example, in a case where the set value of the charging method included in the payment-type restricted view condition is a value indicative of a charging method based on a period, the list 730 of subscription tickets may be provided. A subscription ticket may include a validity period. For example, a monthly subscription ticket may be a subscription right that is valid for one month and is required to view messages for one month. The price of a subscription ticket for a specific validity period may be determined by the set value of the price included in the payment-type restricted view condition for the message.

A view ticket or a subscription ticket selected from the list 720 of view tickets or the list 730 of subscription tickets may be purchased by performing a payment procedure in response to an input selecting a purchase button 740. When the view ticket or the subscription ticket is purchased normally, the payment-type restricted view condition set for the message may be determined to be satisfied, and content 750 of the message may be displayed on the terminal, as shown in screen 703 of FIG. 7C.

For example, in a case where there is an unused view ticket or subscription ticket left on the account of the terminal, the screen 701 may be immediately changed to the screen 703 without the screen 702 of the interface for the payment action, in response to an input selecting the message 710.

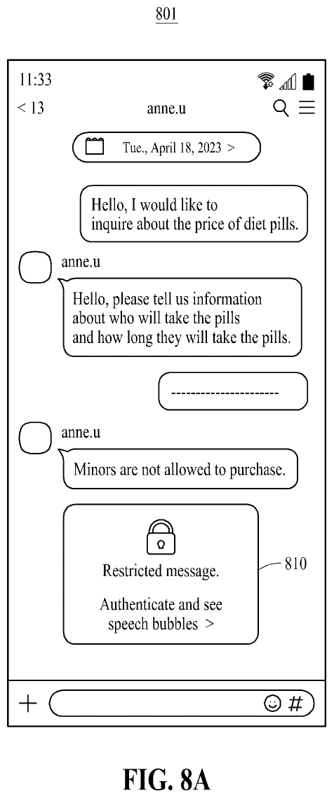

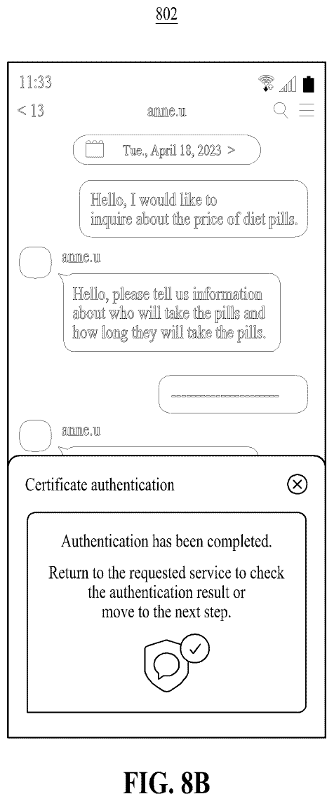

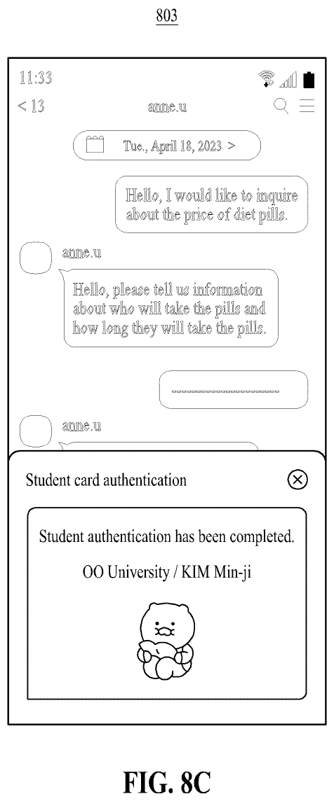

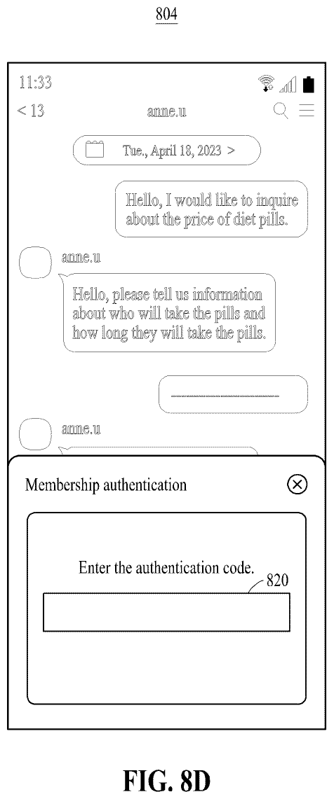

FIGS. 8A through 8D are diagrams illustrating example interface screens of a terminal receiving a message for which an authentication-type restricted view condition is set according to an embodiment.

Screen 801 of FIG. 8A is an example screen of a chat room interface provided through a terminal of a participant in a chat room. Referring to the screen 801, a message 810 for which a condition requiring authentication for viewing is set, which is sent through the chat room, may be displayed on the chat room interface. Before the authentication, content of the message 810 for which the condition requiring authentication for viewing is set may not be displayed on the terminal of the participant. Instead of the content included in the message 810, a symbol may be displayed to indicate that it is a message for which the condition requiring authentication is set.

According to an embodiment, the terminal may request the server to view the message 810. In response to the request to view the message 810 received from the terminal, the server may provide an interface for an authentication action required by the condition requiring the terminal to perform authentication. For example, in response to an input selecting the message 810, a signal requesting the server to view the message 810 may be transmitted, and the interface for performing the authentication action may be provided based on a set value of an authentication-type restricted view condition.

For example, in a case where a set value of an authentication method included in the authentication-type restricted view condition is a value indicative of an identity certificate, the screen 801 may be changed to screen 802 of an interface for the authentication action based on the identity certificate, as shown in FIG. 8B.

For example, in a case where the set value of the authentication method included in the authentication-type restricted view condition is a value indicative of a student ID card, the screen 801 may be changed to screen 803 of an interface for the authentication action based on the student ID card, as shown in FIG. 8C.

According to an embodiment, in a case where the set value of the authentication method is a value indicative of an identity certificate of an account or a value indicative of credential information (e.g., the student ID card), obtained through an authentication server linked with an IMS, an authentication result may be received through the authentication server. For example, referring to the screen 802 of FIG. 8B and the screen 803 of FIG. 8C, the authentication result received through the authentication server may be displayed on the terminal.

For example, in a case where the set value of the authentication method included in the authentication-type restricted view condition is a value indicative of a registered membership authentication code, the screen 801 may be changed to screen 804 of an interface for the authentication action based on the membership authentication code, as shown in FIG. 8D. Referring to the screen 804 of FIG. 8D, an input window 820 for an identifier (e.g., the membership authentication code) may be provided for the authentication action. The identifier input through the identifier input window 820 may be compared to an identifier registered in the IMS, and a result of whether the identifier is authenticated or not may be obtained. For example, when the identifier input through the identifier input window 820 corresponds to the identifier registered in the IMS, authentication may be determined to be successful, and the content of the message for which the authentication-type restricted view condition is set may be displayed on the terminal. In contrast, in a case where the identifier input through the identifier input window 820 does not correspond to the identifier registered in the IMS, authentication may be determined to be unsuccessful, and the content of the message for which the authentication-type restricted view condition is set may not be displayed on the terminal. In this case, a message indicating that authentication has failed may be displayed on the terminal.

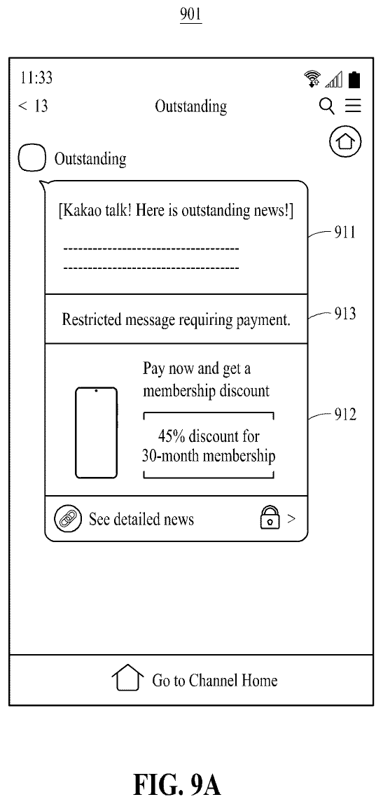

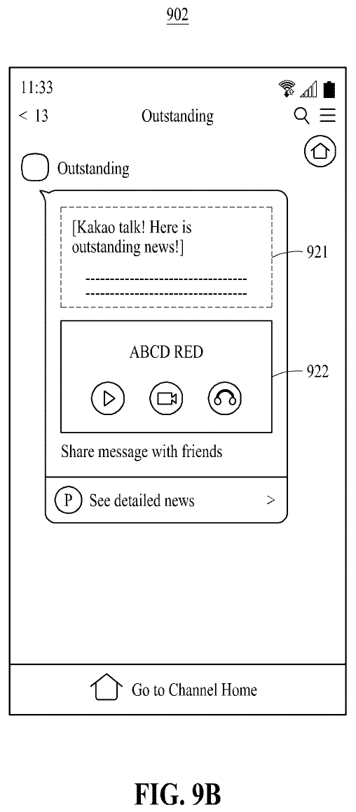

FIGS. 9A and 9B are diagrams illustrating example messages for which a restricted view condition is set for a portion of content according to an embodiment.

Referring to screen 901 of FIG. 9A, in a message including text content and image content, a restricted view condition may be set for a portion of the text content. Another portion of the text content 911 and the image content 912 for which the restricted view condition is not set may be displayed on a terminal, and a partial text content 913 for which a restriction condition is set may be restricted from being displayed. The entire content included in the message may be displayed by performing an action (e.g., a payment action or an authentication action) required by the restricted view condition.

Referring to screen 902 of FIG. 9B, in a message including text content 921 and video content 922, a restricted view condition may be set for the video content 922. The text content 921 for which the restricted view condition is not set may be displayed on the terminal, and the video content 922 for which the restricted view condition is set may be restricted from being displayed and played. A video included in the message may be displayed and played by performing an action (e.g., a payment action or an authentication action) required by the restricted view condition.

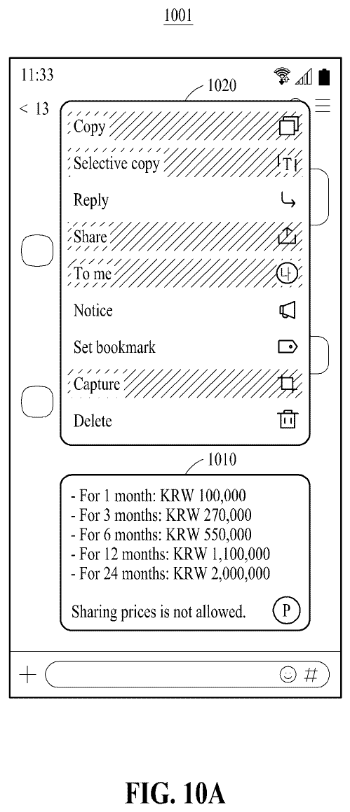

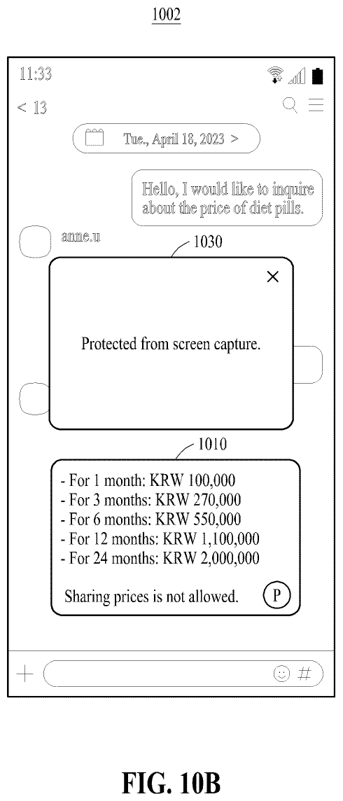

FIGS. 10A and 10B are diagrams illustrating example message for which a sharing-related restriction condition is set according to an embodiment.

As described above, in a case where a sharing-related restriction condition is set for a message, at least one of a sharing function, a copying function, and a capturing function of a terminal for the message may be restricted.

Referring to screen 1001 of FIG. 10A, when a function for a message 1010 is invoked, a function list 1020 in which functions for the message 1010 are listed may be provided. For example, an input invoking a function for the message 1010 may include an input clicking, double tapping, or pressing the message 1010. In a case where the sharing-related restriction condition is set for the message 1010, a sharing-related function on the function list 1020 may be deactivated. For example, displaying functions for copy, selective copy, share, share-with-me, and capture on the function list 1020 may be deactivated, which will cause not to copy, selective copy, share, share-with-me, and capture.

Referring to screen 1002 of FIG. 10B, in a case where the sharing-related restriction condition is set for the message 1010, the capturing function of the terminal may be deactivated while the message 1010 is displayed. For example, when the capturing function of the terminal is invoked while the message 1010 for which the restriction condition is set is being displayed on the terminal, the execution of the capturing function may be restricted. In this case, a message 1030 indicating that the capturing function is not executed may be displayed.

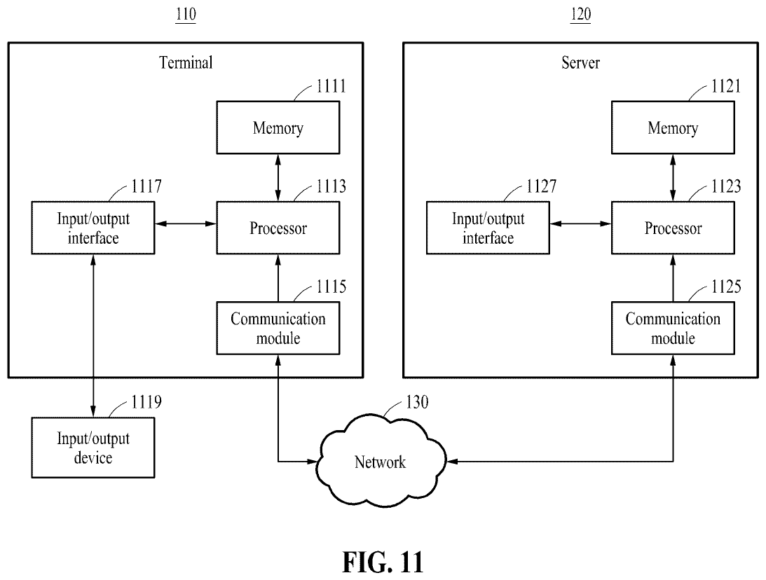

FIG. 11 is a diagram illustrating an example of a hardware configuration of a system for an IMS according to an embodiment.

Referring to FIG. 11, according to an embodiment, a system (e.g., the system 100 of FIG. 1) may include a terminal 110 and a server 120 connected through a network 130.

According to an embodiment, the terminal 110 may be a mobile terminal implemented as a computer device. For example, the terminal 110 may communicate with the server 120 and/or other electronic devices through the network 130 using a wireless or wired communication method.

According to an embodiment, the server 120 may be implemented as a computer device or a plurality of computer devices that communicate with the terminal 110 and/or other servers through the network 130 to provide commands, codes, files, content, services, and the like. The communication method may include, as non-limiting examples, a communication method using a communication network (e.g., a mobile communication network, wired Internet, wireless Internet, a broadcasting network, etc.) that may be included in the network 130 and a short-range wireless communication method between devices. The network 130 may include, for example, at least one of a personal area network (PAN), a local area network (LAN), a campus area network (CAN), a metropolitan area network (MAN), a wide area network (WAN), a broadband network (BBN), or the Internet.

According to an embodiment, the server 120 may provide a file for installing an application (or app) to the terminal 110 connected through the network 130. In this case, the terminal 110 may install the application (e.g., an instant messenger) using the file provided by the server 120. In addition, the terminal 110 may connect to the server 120 under the control of an operating system (OS) and at least one program (e.g., a browser or the installed application) included in the terminal 110 and receive services or content provided by the server 120. For example, when the terminal 110 transmits a service request message to the server 120 through the network 130 under the control of the application, the server 120 may transmit a code corresponding to the service request message to the terminal 110, and the terminal 110 may then provide content to a user by configuring and displaying a screen according to the code under the control of the application.

According to an embodiment, the terminal 110 and the server 120 may each include a memory (e.g., 1111 and 1121), a processor (e.g., 1113 and 1123), a communication module (e.g., 1115 and 1125), and an input/output interface (e.g., 1117 and 1127).

According to an embodiment, the processor (1113 and 1123) may perform at least one of the operations described above with reference to FIGS. 1 to 10. For example, the processor 1113 may perform at least one of the operations performed in the terminal 110 executing the instant messenger described above with reference to FIGS. 4 to 8, and the processor 1123 may perform at least one of the operations for the IMS described above with reference to FIGS. 2 and 3. The processor (1113 and 1123) may be configured to process instructions of a computer program by performing basic arithmetic, logic, and input/output operations. The instructions may be provided to the processor (1113 and 1123) by the memory (1111 and 1121) or the communication module (1115 and 1125).

The memory (1111 and 1121) may be a computer-readable recording medium, which may include a volatile memory or a non-volatile memory. According to an embodiment, the memory (1111 and 1121) may store information for executing the instant messenger described above with reference to FIGS. 1 to 10. For example, the memory 1121 may store user account information and chat room information of a user subscribed to the IMS.

According to an embodiment, the memory 1111 may include a code for the instant messenger that is installed and executed (or run) on the terminal 110 using files provided by the server 120 through the network 130.

According to an embodiment, the memory 1121 may store a program in which the operations for the IMS described above with reference to FIGS. 1 to 10 are implemented.

According to an embodiment, the communication module (1115 and 1125) may provide a function for the terminal 110 and the server 120 to communicate with each other through the network 130 and a function for them to communicate with other electronic devices or other servers.

For example, a request generated by the processor 1113 of the terminal 110 according to a program code for the instant messenger stored in a recording device such as the memory 1111 may be transmitted to the server 120 through the network 130 under the control of the communication module 1115.

For example, control signals, commands, content, files, and the like provided under the control of the processor 1123 of the server 120 may be received by the terminal 110 through the communication module 1115 of the terminal 110 by passing through the communication module 1125 and the network 130.

The input/output interface 1117 may be a means for interfacing with an input/output device 1119. For example, an input device may include a device such as a keyboard or a mouse, and an output device may include a device such as a display for displaying a communication session of an application. For another example, the input/output interface 1117 may be a means for interfacing with a device (e.g., a touchscreen) in which input and output functions are integrated. For example, when processing a command of a computer program loaded on the memory 1111, the processor 1113 of the terminal 110 may display a service screen or content constructed using data provided by the server 120 on a display through the input/output interface 1117. An input received from the user through the input/output device 1119 may be provided in a form that may be processed by the processor 1113 of the terminal 110 through the input/output interface 1117.

According to an embodiment, the terminal 110 and the server 120 may include other components not shown in FIG. 11. For example, the terminal 110 may be implemented to include at least a portion of the input/output device 1119 or may further include other components such as a transceiver, a global positioning system (GPS) module, a camera, various sensors, a database (DB), and the like.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating an instant messaging server, the method comprising:
sending, through a chat room, a message for which display of content is restricted based on settings of a restricted view condition for the message;
receiving a request to view the message from a terminal of a participant in the chat room; and
activating the display of the content of the message on the terminal of the participant, based on whether the participant satisfies the restricted view condition.

2. The method of claim 1, wherein the activating of the display of the content of the message comprises:
in response to the participant not satisfying the restricted view condition,
requesting the terminal of the participant for an action required by the restricted view condition; and
activating the display of the content of the message on the terminal of the participant based on the required action being performed.

3. The method of claim 2, further comprising:
in response to the required action not being performed, deactivating the display of the content of the message on the terminal of the participant.

4. The method of claim 2, wherein the action required by the restricted view condition comprises at least one of a payment action and an authentication action.

5. The method of claim 1, further comprising:
setting the restricted view condition for the message, based on a set value of the restricted view condition input from a terminal of a sender of the message.

6. The method of claim 1, wherein the restricted view condition comprises at least one of:
a payment-type restricted view condition that requires a payment to view; or
an authentication-type restricted view condition that requires authentication to view.

7. The method of claim 1, wherein the restricted view condition is set for at least a portion of the content comprised in the message.

8. The method of claim 1, wherein the restricted view condition is set for each participant in the chat room.

9. The method of claim 1, wherein the message, for which the restricted view condition is set, is restricted in at least one of sharing, copying, and capturing.

10. A method of operating a terminal executing an instant messenger, the method comprising:
determining a type of a restriction condition for a message;
determining a set value of the restriction condition based on the determined type; and
requesting transmission of the message for which the restriction condition is set, based on the set value.

11. The method of claim 10, wherein the type of the restriction condition comprises at least one of:
a payment-type restricted view condition that requires a payment to view; or
an authentication-type restricted view condition that requires authentication to view; or
a sharing-related restriction condition.

12. A method of operating a terminal executing an instant messenger, the method comprising:
receiving a message for which a restricted view condition is set;
performing an action required by the restricted view condition; and
displaying content of the message based on a result of performing the required action.

13. A non-transitory computer-readable storage medium storing instructions that, when executed by one or more processors, cause the one or more processors to perform the method of claim 1.

14. An instant messaging server, comprising:
at least one processor configured to:
send, through a chat room, a message for which display of content is restricted based on settings of a restricted view condition for the message;
receive a request to view the message from a terminal of a participant in the chat room; and
activate the display of the content of the message on the terminal of the participant, based on whether the participant satisfies the restricted view condition.

15. The instant messaging server of claim 14, wherein the at least one processor is configured to:
when activating the display of the content of the message,
in response to the participant not satisfying the restricted view condition, request the terminal of the participant for an action required by the restricted view condition; and
activate the display of the content of the message on the terminal of the participant based on the required action being performed.

16. The instant messaging server of claim 15, wherein the at least one processor is configured to:
in response to the action not being performed, deactivate the display of the content of the message on the terminal of the participant.

17. The instant messaging server of claim 14, wherein the at least one processor is configured to:
set the restricted view condition for the message, based on a set value of the restricted view condition input from a terminal of a sender of the message.

18. The instant messaging server of claim 14, wherein the restricted view condition comprises at least one of:
a payment-type restricted view condition that requires a payment to view; or
an authentication-type restricted view condition that requires authentication to view.

19. A terminal executing an instant messenger, the terminal comprising:
at least one processor configured to:
determine a type of a restriction condition for a message;
determine a set value of the restriction condition based on the determined type; and
request transmission of the message for which the restriction condition is set, based on the set value.

20. A terminal executing an instant messenger, the terminal comprising:
at least one processor configured to:
receive a message for which a restricted view condition is set;
perform an action required by the restricted view condition; and
display content of the message based on a result of performing the action.
